(19) United States
(12) Patent Application Publication
(10) Pub. No.: US 2013/0290024 A1
(43) Pub. Date: Oct. 31, 2013

(54) DISPLAY DEVICE AND DISPLAY CONTROL PROGRAM FOR THE SAME

(71) Applicant: GE MEDICAL SYSTEMS GLOBAL TECHNOLOGY COMPANY, Waukesha, WI (US)

(72) Inventors: Tatsuo Kawanaka, Tokyo (JP); Takuya Shimomura, Tokyo (JP)

(73) Assignee: GE MEDICAL SYSTEMS GLOBAL TECHNOLOGY COMPANY, LLC, Waukesha, WI (US)

(21) Appl. No.: 13/685,102

(22) Filed: Nov. 26, 2012

(30) Foreign Application Priority Data
Apr. 27, 2012 (JP) 2012-101915

(51) Int. Cl. G06F 19/00

(52) U.S. Cl. CPC G06F 19/3487
USPC 705/3

(57) ABSTRACT

A display device including a display control unit is provided. The display control unit is configured to display, in a display screen, a list image including a list of medical data that includes a part of a plurality of pieces of medical data of a patient having different time information. The display control unit is further configured to display a period image illustrating a total period from an oldest time to the present in time information of the medical data of the patient such that the total period fits in the display screen, wherein the display control unit is configured to display, in the period image, a partial period from an oldest time to a latest time of the time information of the medical data included on the displayed list of medical data.

### CROSS REFERENCE TO RELATED APPLICATIONS

This application claims the benefit of Japanese Patent Application No. 2012-101915 filed Apr. 27, 2012, which is hereby incorporated by reference in its entirety.

### BACKGROUND OF THE INVENTION

The present invention relates to a display device in which a list image showing a list of medical data of patients is displayed and a display control program for the same.

A medical information display device connected to a server via a network and displaying an image based on medical data stored in the server is described in, for example, Japanese Unexamined Patent Application Publication No. 2010-182018.

The medical data stored in the server is, for example, data of a medical image such as an X-ray CT image captured by an X-ray CT (Computed Tomography) apparatus or an MRI image captured by an MRI (Magnetic Resonance Imaging) apparatus. The medical data also include data obtained by scanning a paper document used in a hospital such as diagnosis information providing document.

In recent years, because of improvement in computation performance and storage capacity of a computer, cooperation among hospitals, and the like, reference to medical data in a long term, which has been difficult in the past, comes to be realized. There is a case of displaying a list image of a list of medical data obtained in the past of a patient. In the case of displaying a list image, it is difficult to display all of a list of medical data in a long period while assuring visibility. Consequently, a list of only a part of stored medical data of a patient is displayed.

However, in the case of displaying a list of only a part, the time of a list being presently displayed is not easily known. Particularly, there is a circumstance that a generation date of medical data varies among patients. Specifically, the period and frequency of generating medical data vary among patients because there are cases such as a case that medical data is generated periodically in a regular examination or the like and a case that medical data is generated concentrated in a certain period due to sickness or the like. Even for the same patient, the period and frequency of generating medical data vary depending on symptoms. Such circumstances make the generation time of a list which is presently displayed harder to be understood, and there are consequently needs to make the generation time of medical data displayed in a screen of a patient recognized at a glance.

### BRIEF DESCRIPTION OF THE INVENTION

In a first aspect, a display device is provided. The display device is characterized by having a display control unit for displaying, in a display screen, a list image showing a list of medical data in a period of a part of a plurality of pieces of medical data of a patient having different time information and displaying a period image indicating a period from oldest time to present in time information of the medical data of the patient so as to be fit in the display screen, wherein the display control unit displays, in the period image, a period from the oldest time to the latest time of the time information of the medical data corresponding to the list image displayed in the display screen.

In a second aspect, the display device in the above-described aspect is provided in which the display control unit displays, in a display screen, an instruction image showing time information in the medical data, in a period illustrated by the period image.

According to the first aspect, the period image indicative of a period from the oldest time to present in the time information of the medical data of the patient is displayed so as to be fit in the display screen, and a period from the oldest time to present in the time information of medical data corresponding to a list image displayed in the display screen is displayed in the period image, so that the generation time of the medical data can be easily recognized at a glance.

According to the second aspect, an instruction image showing time information in the medical data, in a period illustrated by the period image is displayed. Consequently, the time and frequency of generation of the medical data can be easily grasped.

### BRIEF DESCRIPTION OF THE DRAWINGS

FIG. 1 is a block diagram of a medical use image display system according to an exemplary embodiment.

FIG. 2 is a block diagram illustrating the configuration of a display control unit in a display terminal.

FIG. 3 is a flowchart showing the operation of the medical use image display system illustrated in FIG. 1.

FIG. 4 is a diagram illustrating an example of a display screen in which a list image, a period image, and an instruction image at the time of generation are displayed.

FIG. 4A is an enlarged portion of the display screen shown in

FIG. 4.

FIG. 5 is a diagram illustrating another example of the display screen in which a list image, a period image, and an instruction image at the time of generation are displayed.

FIG. 5A is an enlarged portion of the display screen shown in FIG. 5.

FIG. 6 is a diagram illustrating another example of a display screen in which a list image, a period image, and an instruction image at the time of generation are displayed in a modification of the embodiment.

FIG. 6A is an enlarged portion of the display screen shown in FIG. 6.

### DETAILED DESCRIPTION OF THE INVENTION

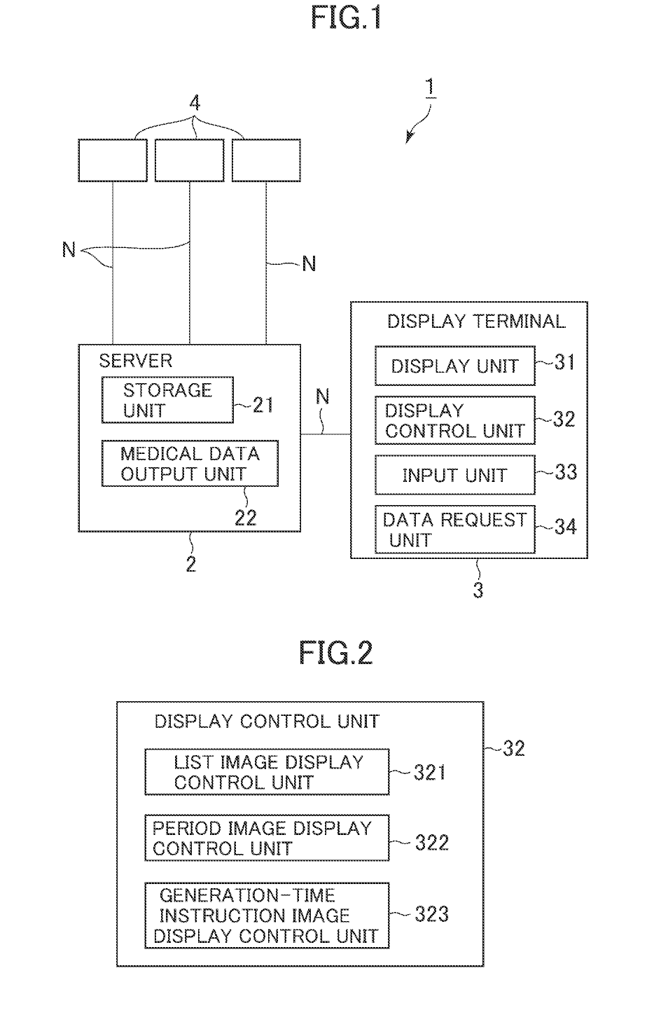

Hereinafter, an exemplary embodiment will be described with reference to FIGS. 1 to 5A. A medical use image display system 1 illustrated in FIG. 1 has a server 2 and a display terminal 3 connected to each other via a network N. To the server 2, a plurality of section systems 4 are connected via networks N. The display terminal 3 is an exemplary embodiment of the display device.

The server 2 has a storage unit 21 and a medical data output unit 22. The storage unit 21 is, for example, an HDD (Hard Disk Drive). In the storage unit 21, medical data and the like supplied to the server 2 from each of the section systems 4 via the network N is stored.

Medical data stored in the storage unit 21 is data related to a patient generated in a medical providing facility, a test facility which conducts a laboratory test, or the like, and is medical image data or document data. The medical image data is data obtained by a modality or the like of the section system 4 and is, for example, image data of an X-ray CT image, an MRI image, an ultrasonic image, or the like. Document data is, for example, a data of a radiogram interpretation report, a diagnosis information providing document, a consent form such as a surgical consent form or an examination consent form, a medical interview sheet, an examination result, and the like. The document data includes PDF (Portable Document Format) data obtained by scanning a paper document.

The medical data includes not only the medical image data and the document data listed in the above description but also data of course a record of biometric information of a patient such as electrocardiogram and other records related to the patient.

The medical data includes accompanying information in addition to the data itself. The accompanying information is, for example, the name of a patient, date, the kind of an examination, the kind of a document, and the like. The accompanying information includes, for example, information automatically given in the section system 4 such as a modality of an X-ray CT device and information given by an input of an operator.

The date in the accompanying information is, for example, a generation date of medical data. The date in the accompanying information may include not only a date but also year, time, and the like. In the case of medical image data, an image capture date may be set to the generation date. In the case of document data, a date of generation of a document may be the generation date or a date of generating data by scanning a document may be the generation date. The date in the accompanying information is an example of an exemplary embodiment of time information.

The medical data output unit 22 outputs medical data stored in the storage unit 21 to the display terminal 3 in response to a request of the display terminal 3.

The display terminal 3 is a general personal computer. The display terminal 3 has a display unit 31, a display control unit 32, an input unit 33, and a data request unit 34.

The display unit 31 is an LCD (Liquid Crystal Display), a CRT (Cathode Ray Tube), or the like.

As shown in FIG. 2, the display control unit 32 has a list image display control unit 321, a period image display control unit 322, and a generation-time instruction image display control unit 323. By a program stored in a storage unit (not shown), the display control function in the display control unit 32, that is, the functions of the list image display control unit 321, the period image display control unit 322, and the generation-time instruction image display control unit 323 are executed. The details will be described later. The display control unit 32 is an example of an exemplary embodiment of the display control unit and executes the display control function.

The input unit 32 is constructed by a keyboard, a mouse, and the like. The data request unit 34 outputs a signal requesting medical data to the server 2 on the basis of an input of the operator in the input unit 33.

The section system 4 is, for example, a section system in a hospital such as a radiology information system (RIS) including modalities such as an X-ray CT device and an MRI device and a clinical laboratory system.

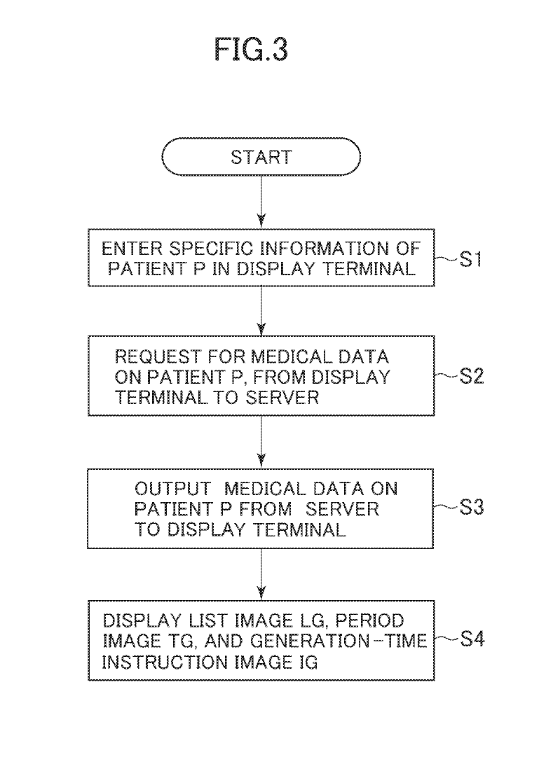

Next, the operation of the medical use image display system 1 of the exemplary embodiment will be described with reference to the flowchart of FIG. 3. First, in step S1, the operator enters specific information of a patient P such as name and ID with the input unit 33 of the display terminal 3. Next, in step S2, the data request unit 34 requests the server 2 for medical data related to the patient P whose specific information is entered in the step S1.

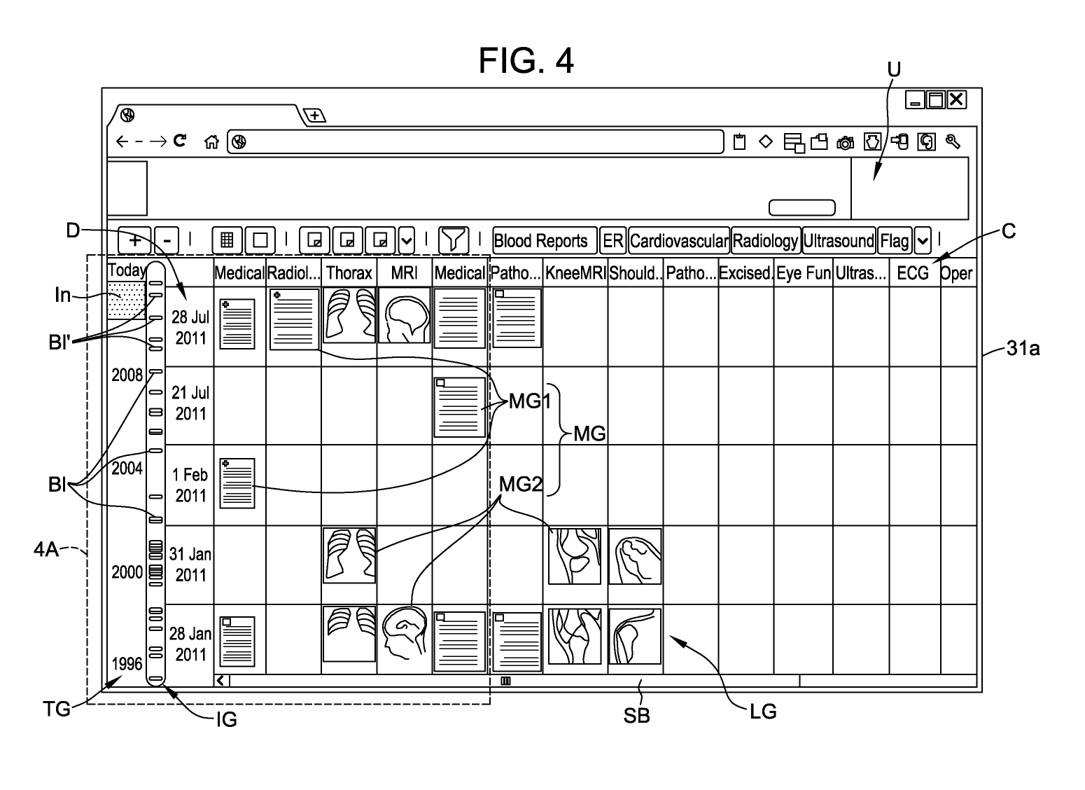

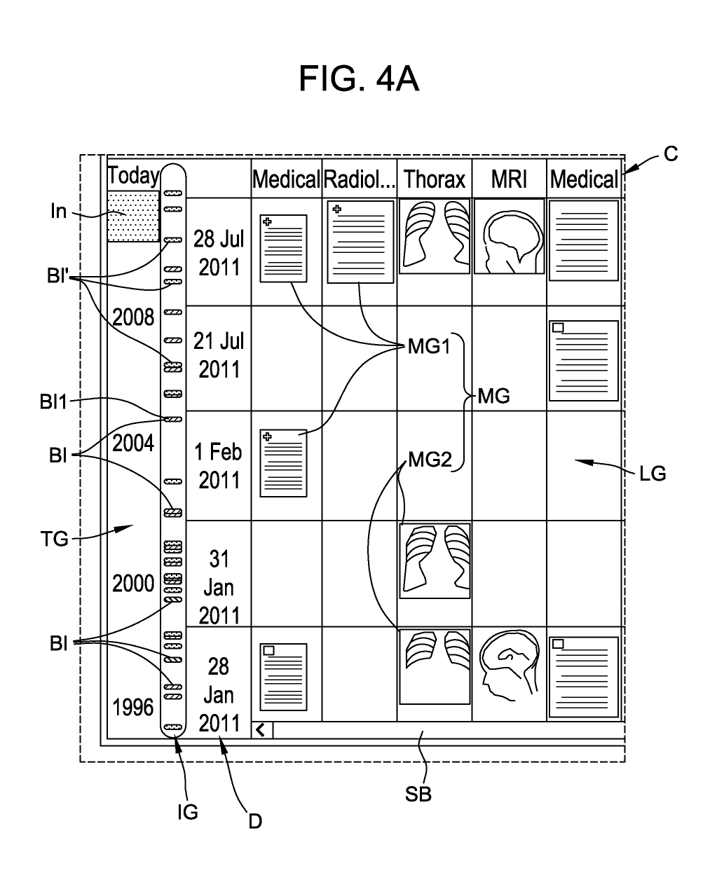

In step S4, as illustrated in FIGS. 4 and 4A, the display control unit 32 displays a list image LG, a period image TG, and a generation-time instruction image IG on a display screen 31a of the display unit 31. The display control unit 32 may display the name of a patient, an operation button, and the like in a column U above the list image LG, the period image TG, and the generation-time instruction image IG in the display screen 31a.

In step S4, as illustrated in FIG. 4, the display control unit 32 displays a list image LG, a period image TG, and a generation-time instruction image IG on a display screen 31a of the display unit 31. The display control unit 32 may display the name of a patient, an operation button, and the like in a column “U” above the list image LG, the period image TG, and the generation-time instruction image IG in the display screen 31a.

Display of the list image LG, the period image TG, and the generation-time instruction image IG will be described in detail. First, display of the list image LG will be described. The list image display control unit 321 displays the list image LG on the basis of the medical data supplied from the server 2.

The list image LG is a list of medical use images MG such as an image MG1 of a document based on the document data and a medical image (such as an X-ray CT image and an MRI image) MG2 based on the medical image data. In the list image LG, the medical use images MG are displayed as reduced images. The operator clicks the medical use image MG with the input unit 33 to display an enlarged medical use image MG by the display control unit 32.

The list image LG is an image in which the medical use images MG are arranged in a matrix. The vertical direction (vertical direction in the screen) of the list image LG indicates date, and the horizontal direction (lateral direction in the screen) shows the kind of the medical use image MG, that is, document kind. Concretely, the list image LG has the date column D indicating generation date of medical data in the vertical direction and an image kind row C indicative of kinds of the medical use images MG in the horizontal direction. Therefore, in the list image LG images in a row are medical use images generated on the same date, and images in a column are medical use images of the same kind. The dates in the list image LG are based on, for example, accompanying information.

In the list image LG shown in FIG. 4, only a part of the medical use image MG based on the medical data stored in the server 2 of the patient P is displayed. Scrolling in the horizontal direction, that is, the direction of the image kind row C can be performed by operating a scroll bar SB with the input unit 33. On the other hand, scrolling in the vertical direction can be performed by clicking a block Bl on the generation-time instruction image IG. The details will be described later.

Next, display of the period image TG will be described. The period image display control unit 322 displays the period image TG. The period image TG is a band-shaped image which is long in the vertical direction and has a length indicative of a period T_{ALL} from the oldest day among the generation dates of medical data stored in the server 2 of the patient P to the present (today). The period image TG is displayed so as to be fit in the screen, and all of the period T_{ALL} is fit in the screen.

The period image display control unit 322 specifies the oldest date in the generation dates of the medical data stored in the server 2, of the patient P with reference to the accompanying information.

In the period image TG, the intervals of time are indicated by a linear scale, that is, length of equal intervals. In FIG. 4, the period T_{ALL} indicated in the period image TG is from 1996 to the present, and the intervals of time in the period T_{ALL} are shown by the lengths of equal intervals. Concretely, the period image TG has numerals of “1996” indicative of the year of 1996, numerals “2000” indicative of the year of 2000, numerals “2004” indicative of the year of 2004, numerals “2008” indicative of the year of 2008, and characters “Today” indicative of the present. If the present is the year of 2012, in the period image TG, numerals and characters are displayed every four years, and all of the four year periods have lengths of equal intervals.

The period image display control unit 322 displays, in the period image TG, a band-shaped indicator. In indicative of a period T_{PART} from the oldest date to the latest date among generation dates of medical data corresponding to the list image LG displayed in the display screen 31a. The band-shaped indicator In is displayed in a color different from the other part in the period image TG. It is sufficient that the band-shaped indicator. In is displayed in a form different from the other part of the period image TG.

The period image display control unit 322 displays the band-shaped indicator In in a part corresponding to the period T_{PART} in the period image TG. The period T_{PART} is a period from the date in the lowermost line to the date in the uppermost line in the list image LG. In FIG. 4, in the period image TG, the band-shaped indicator In is displayed in the period from Jan. 28, 2011 to Jul. 28, 2011.

The period image display control unit 322 specifies the oldest date and the latest date in the generation dates of the medical data corresponding to the medical use image MG displayed in the display screen 31a with reference to the accompanying information and displays the band-shaped indicator In.

As will be described later, the period image display control unit 322 moves the indicator In in association with scrolling of the list image LG. The indicator In moves over the period image TG.

By displaying the band-shaped indicator In in the period image TG displayed so as to be entirely fit in the screen as described above, when in the period T_{ALL} the medical data corresponding to the list image LG displayed in the display screen 31a was generated can be easily recognized at a glance.

Next, display of the generation-time instruction image IG will be described. The generation-time instruction image display control unit 323 displays the generation-time instruction image IG. The generation-time instruction image IG is the block Bl which is long in the horizontal direction and indicates generation time of the medical data in the period T_{ALL} indicated by the period image TG. That is, by the block Bl, when the medical data was generated in the period T_{ALL} indicated by the period image TG is shown. The generation-time instruction image IG is an exemplary embodiment of the instruction image.

By display of such a block Bl, the time and the frequency of generation of medical data can be easily grasped. For example, in a period in which the display intervals of the block Bl are regular intervals, it can be easily grasped that medical data is generated by periodic examinations. On the other hand, in a period in which the blocks Bl are displayed concentratedly, it can be easily grasped that medical data is generated concentratedly in a short period because of sickness or the like.

In the exemplary embodiment, the block Bl is not shown every day but expresses generation time using a predetermined period having a unit longer than one day such as a few days. The block Bl may have a display mode according to the number of pieces of medical data in a predetermined period. For example, the block Bl may be expressed by a gray scale which becomes close to black as the number of pieces of medical data in a predetermined period increases and comes to close to white as the number of pieces of medical data in a predetermined period decreases.

The generation-time instruction image display control unit 323 may display a block Bl′ corresponding to medical data designated by, for example, being tagged by an operator or the like, in a display mode different from that of the block Bl corresponding to medical data which is not designated. More specifically, in the case where medical data designated by, for example, preliminarily tagged by an operator or the like is included in a predetermined period indicated by the block Bl, the generation-time instruction image display control unit 323 may display the block Bl′ in a display mode different from that of another block Bl. For example, the block Bl′ is displayed in a color having a predetermined hue (in the diagram, the block Bl′ is shown by dots). As described above, by displaying the block B1′, medical data to be noted can be easily found.

By clicking the block Bl or Bl′ by the operator, the list image LG can be scrolled in the vertical direction. Concretely, when the operator places a pointer over the block Bl or Bl′ and clicks it with the input unit 33, the list image display control unit 321 displays the medical use image MG of medical data included in the period corresponding to the clicked block Bl or Bl′ as the list image LG. As the list image LG, the medical use image MG of the medical data included in the period corresponding to a clicked block Bl or Bl′ and close to the clicked block Bl or Bl′ may be displayed as long as it can be displayed in the display screen 31a.

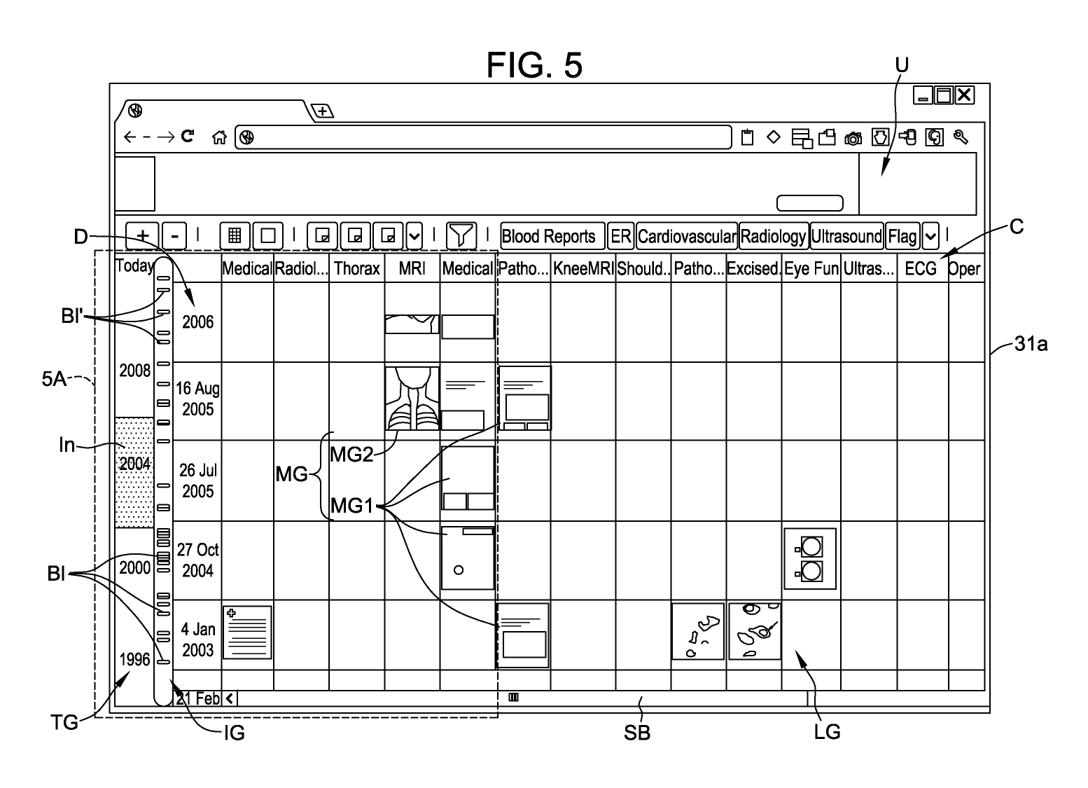

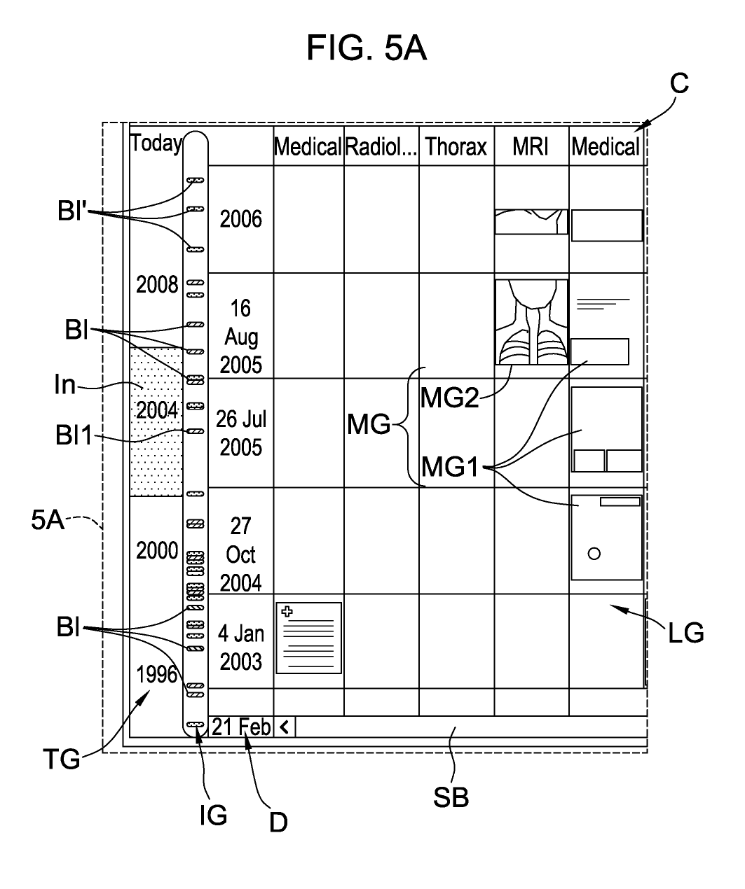

For example, when a block B11 is clicked in a state illustrated in FIGS. 4 and 4A, medical use images MG of medical data included in the period corresponding to the block B11 and a nearby block Bl are displayed as the list image LG as illustrated in FIGS. 5 and 5A. In association with it, the band-shaped indicator In also moves to the corresponding part in the period image TG.

By clicking the block Bl, the list image LG is scrolled to find a medical use image MG desired to be enlargedly displayed. On the other hand, although the band-shaped indicator In moves with the scrolling of the list image LG, the period image TG is fit in the display screen 31a and is not scrolled. Therefore, the period of the medical data as the base of the medical use images MG in the list image LG displayed by being scrolled can be easily grasped.

Since the time intervals in the period image TG are equal intervals, the length of the band-shaped indicator In changes according to the period T_{PART}. When the number of medical data in a certain period is small, the generation period of medical data corresponding to medical use images MG displayed in the list image LG is long, so that the period T_{PART} becomes long and the band-shaped indicator In becomes long. On the other hand, when the number of medical data in a certain period is large, the generation period of medical data corresponding to medical use images MG displayed in the list image LG is short, so that the period T_{PART} becomes short and the band-shaped indicator In becomes short.

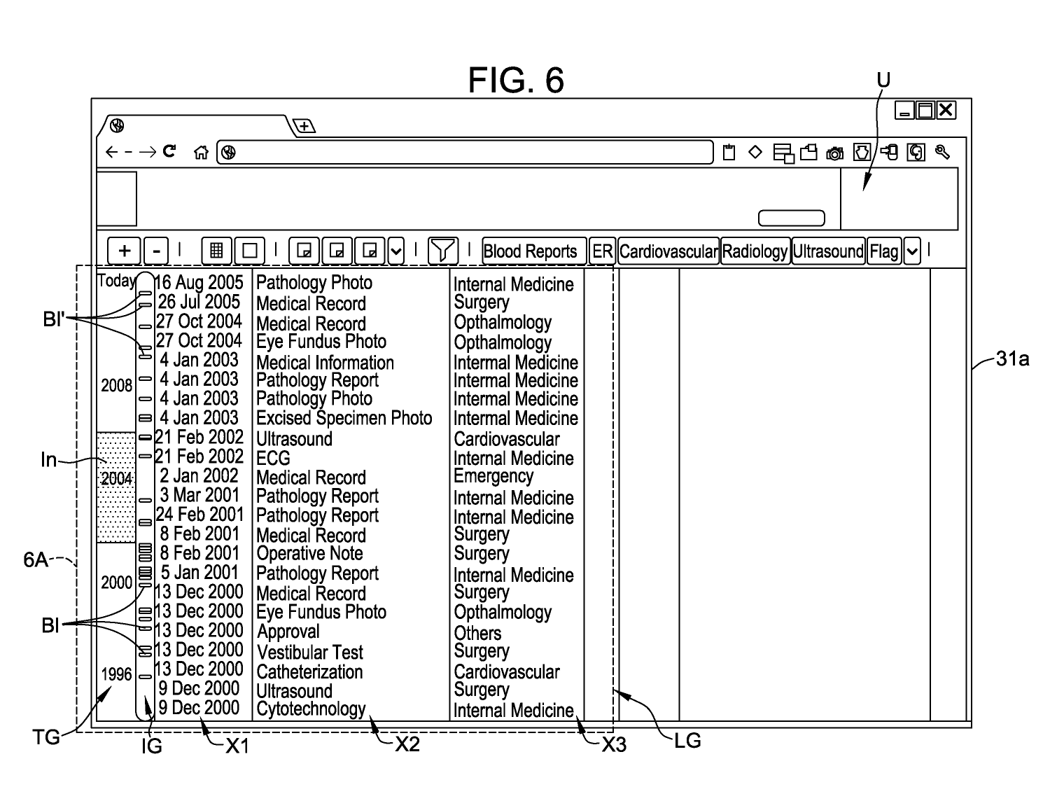

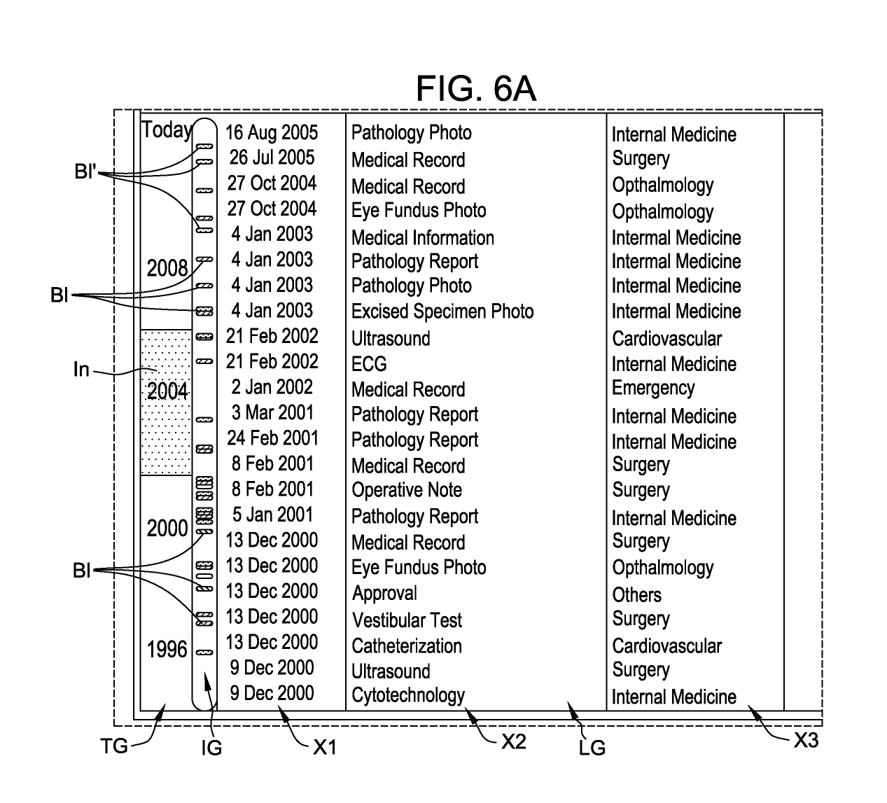

Next, a modification of the embodiment will be described. As illustrated in FIGS. 6 and 6A, the list image LG is not a list of the medical use images MG but an image of a list of information accompanying medical data. In the exemplary embodiment, accompanying information displayed in the list image LG is a generation date of medical data, a document kind of medical data, and a section (examination requesting section) requesting for generation of medical data. Characters indicative of the generation date of medical data are displayed in a first column X1, characters indicative of the document kind of medical data are displayed in a second column X2, and characters indicative of the requesting section are displayed in a third column X3. In the list image LG, one row corresponds to one piece of medical data. When any one of the rows is clicked, the display control unit 32 displays a medical use image based on the corresponding medical data.

Also in the exemplary embodiment shown in FIGS. 6 and 6A, the period image display control unit 322 displays the band-shaped indicator In indicating the period T_{PART} from the date of the lowermost row in the list image LG displayed in the display screen 31a to the date of the uppermost row over the period image TG.

Although exemplary embodiments are described herein, the systems and methods disclosed can be variously changed without departing from the spirit and scope of the disclosure. For example, the list image LG is an example and is not limited to the above-described one. As an example, the display control unit 32 may extract only specific medical data by the retrieval function which referred to accompanying information and the like and display it as the list image LG. Although the document kinds are arranged in the horizontal direction in the list image LG illustrated in FIGS. 4 and 5, the invention is not limited to the arrangement. For example, although not illustrated, in the list image LG, medical use images MG by requesting sections may be arranged in the horizontal direction, or medical use images MG by hospitals in which medical data is generated may be arranged in the horizontal direction.

1. A display device comprising a display control unit configured to:
display, in a display screen, a list image including a list of medical data that includes a part of a plurality of pieces of medical data of a patient having different time information; and
display a period image illustrating a total period from an oldest time to the present in time information of the medical data of the patient such that the total period fits in the display screen, wherein the display control unit is configured to display, in the period image, a partial period from an oldest time to a latest time of the time information of the medical data included on the displayed list of medical data.

2. The display device according to claim 1, wherein the period image is an elongated image having a length indicative of the total period.

3. The display device according to claim 2, wherein intervals of time in the period image are equal intervals.

4. The display device according to claim 1, wherein time information in the medical data is included in accompanying information of the medical data, and the display control unit is configured to specify the oldest time and the latest time in the time information in the medical data of the patient with reference to the accompanying information.

5. The display device according to claim 2, wherein time information in the medical data is included in accompanying information of the medical data, and the display control unit is configured to specify the oldest time and the latest time in the time information in the medical data included on the displayed list of medical data with reference to the accompanying information.

6. The display device according to claim 3, wherein time information in the medical data is included in accompanying information of the medical data, and the display control unit is configured to specify the oldest time and the latest time in the time information in the medical data included on the displayed list of medical data with reference to the accompanying information.

7. The display device according to claim 1, wherein the display control unit is configured to display an indicator indicating the partial period, the indicator moved when the list image is scrolled.

8. The display device according to claim 2, wherein the display control unit is configured to display an indicator indicating the partial period, the indicator moved when the list image is scrolled.

9. The display device according to claim 3, wherein the display control unit is configured to display an indicator indicating the partial period, the indicator moved when the list image is scrolled.

10. The display device according to claim 4, wherein the display control unit is configured to display an indicator indicating the partial period, the indicator moved when the list image is scrolled.

11. The display device according to claim 5, wherein the display control unit is configured to display an indicator indicating the partial period, the indicator moved when the list image is scrolled.

12. The display device according to claim 6, wherein the display control unit is configured to display an indicator indicating the partial period, the indicator moved when the list image is scrolled.

13. The display device according to claim 1, wherein the display control unit is configured to display, in the display screen, an instruction image showing a time of the time information in the medical data for the total period.

14. The display device according to claim 13, wherein the display control unit is configured to display the instruction image in a display mode which varies according to a number of pieces of the medical data.

15. The display device according to claim 13, wherein the display control unit is configured to display the instruction image corresponding to the medical data which is preliminarily designated in a display mode different from a display mode for the instruction image corresponding to the medical data which is not designated.

16. The display device according to claim 13, wherein when the instruction image is designated by an operator, and wherein the display control unit is configured to display at least the list image corresponding to the instruction image.

17. The display device according to claim 1, wherein the medical data includes document data or medical image data obtained by a modality.

18. The display device according to claim 1, wherein the list image is an image in which reduced images of medical use images based on the medical data are arranged in a matrix by dates included in the time information.

19. The display device according to claim 1, wherein the list image is an image of a list of accompanying information of the medical data.

20. A display control program for a display device, the display control program configured to make a computer execute a display control function that includes:
displaying, in a display screen, a list image including a list of medical data that includes a part of a plurality of pieces of medical data of a patient having different time information; and
displaying a period image illustrating a total period from an oldest time to the present in the time information of the medical data of the patient such that the total period fits in the display screen, wherein the display control function displays, in the period image, a partial period from an oldest time to a latest time of the time information of the medical data included on the displayed list of medical data.
